(19) United States
(12) Patent Application Publication
(10) Pub. No.: US 2018/0264876 A1
(43) Pub. Date: Sep. 20, 2018

(54) Art Travel Kit

(71) Applicant: Kenneth R. Davis, Altadena, CA (US)

(72) Inventor: Kenneth R. Davis, Altadena, CA (US)

(21) Appl. No.: 15/460,226

(22) Filed: Mar. 15, 2017

(51) Int. Cl. B44D 3/04; B44D 3/02; B44D 3/18; A45C 13/02; A45C 13/10; A45C 11/24; A45C 11/34; A45C 13/00

(52) U.S. Cl. CPC B44D 3/04; B44D 3/02; B44D 3/18; A45C 13/005; A45C 13/1069; A45C 11/24; A45C 11/34; A45C 13/02

(57) ABSTRACT

A compact travel art kit. The Kit solves three major issues, lacking in combination in other kits: 1. Rapid Setup: Simply open the hinged lid, flip out the trays, pick up tools and begin creating within seconds. Fast startup is accomplished by having all essential artists tools and supplies within the Kit. Artwork can be created completely within the Kit. When finished, simply close the kit and go. 2. Versatility and Extensive Configuration. Included are container options which allow various media to be switched out via use of palette containers. The Kit is tripod mountable, plus has a secure hand-holder attachment that allows the artist to draw or paint while standing. Additional unique features include water evacuation system, brush holders and easel extender. 3. Portability: The Kit is small, lightweight and easy to carry. This kit is the ideal companion for traveling abroad or traveling around town.

### BACKGROUND OF INVENTION

Art can be said to be as old as humanity. Cave paintings (also known as “parietal art”) are on the walls or ceilings, mainly of prehistoric origin, dating back some 40,000 years ago.

Art eventually found its way out of the shadows into the sunlight. Ancient rock art can be found in open air sites around the world. As people drifted further away from their homes to create art, they had to invent tools and supplies that could easily travel with them.

Recent history has seen the rise of painting ‘en plein air’, a French term meaning to paint ‘in the open air’. This movement quickly spread beyond France to England, the United States and around the world. Today, there are art organizations, informal groups and individual artists who ardently practice the art of plein air painting.

However, as we are looking back on recent history (the mid-19th century) of painting on location, artists and inventors began to address the challenges of easily transporting tools and supplies further from their studios. The Pochade Box, a compact wooden box used to hold paints and brushes in a free-standing easel configuration became a popular solution more and is still used today.

As modes of travel advanced, allowing artist to create beyond their community and region, more compact art kits were needed. Today, an industry has grown out of the demand of artists to have just the right tools for creating work on the go. Of the more popular plein air field boxes, most of them are less for daily use, more for weekend excursions or special occasions. Those art rigs are typically big, bulky, heavy and require numerous adjustments that steal time from the spontaneity of creating art.

### CROSS REFERENCE TO RELATED APPLICATIONS

The ‘Field Easel With Integrated Paint/Sketch Box U.S. Pat. No. 7,717,393-2010 A1 is an example of the ‘weekend excursion’ boxes. These types are often made of wood and often, though not always, rely on some sort of tripod configuration in order to use them. They also tend to be utilitarian in appearance. The same might be said for the ‘Portable Easel and Palette Combination’ U.S. Pat. No. 7,188,818 B2. Another example is U.S. Pat. No. 3,202,471. These boxes are not typically used daily in casual settings (coffee shops, shopping malls, etc.) unless employed by prolific and/or professional artists.

While the ‘Paint 'N Carry’ US 2009/0321282 A1 system has a more artistic appearance and boasts of containing the essentials to paint with, it is much too large (241/2″×171/2″) to use in small spaces, such as on a airplane flight. Nor does it have the capability to safely hold in one hand while creating with the other.

The ‘Portable Art Pack’ US 2005/0274631 is designed for the traveling artist. Art supplies are stored within a canvas bag measuring approximately 14″×24″ unfolded. While it accommodates a variety of art materials, they are not laid out in a way that makes them easy to access. For example, when folded into a working position, the drawing/painting surface is on one side of the bag while most of the art supplies are out of view on the other side. When working with kits contained within the bag, such as the Winsor & Newton watercolor kit shown in FIG. 3, it is necessary to sit or have some place to hold extra items while painting. Also, while this is indeed an attractive travel kit, the size renders it not practical in small spaces. Also, the material (canvas) used to make the bag is susceptible to paint stains and grime expected during art excursions.

Of the smaller travel kits, some have essential features, but prevent an artist from arriving on a scene and beginning the creative process quickly and unencumbered. Or, they might not be standardized to accommodate supplies already on the market.

The ‘Artist Water Color Kit’ U.S. Pat. No. 3,414,343 This kit, while targeted toward the travel kit category, has limited features. It appears to not have storage space for brushes, pens and/or pencils. It also is constructed of sheet metal, a feature listed in the description. which could generate too much heat to hold in ones hand on a hot day. It also has numerous detachable/attachable parts and adjustment functions which will delay the painting process.

The ‘Art Travel Kit’ has been designed to meet those needs mentioned above. It will satisfy the most discerning and demanding of traveling artists. Keni, the inventor of Keni's Art Kit has been painting ‘en plein air’ for over 50 years. Keni spent a year designing, prototyping and testing versions his kit, having completed numerous versions and rigorously tested it with 200 works of art. The kit which is being submitted for patent is the culmination of that stringent design work and testing. It is a kit is highly functional. It is compact enough to be used in the coach section of a passenger plane, plus rugged enough to be used by a soldier on the battle field. Also, it is elegant enough to be taken and used at a black tie affair;

### FIELD OF INVENTION (BRIEF SUMMARY)

The present invention relates to art travel kits with interchangeable and extendable interior parts that allow the kit to be used with various wet and dry media and with various sized easels.

### BRIEF DESCRIPTION OF THE DRAWINGS

FIG. 1: Shows a perspective view of the present embodiment of the Kit in the closed position illustrating its distinctive lid, water evacuation spout and the inventor's trademark ‘K’ logo embossed on the base front.

FIG. 2: A frontal perspective view of the present embodiment of the Kit in the open position.

FIG. 3: The perspective view of the Kit focuses on the hinged mixing trays; illustrating how they are folded within the Kit when in the closed, stored position and how they rotate out 180° to the open position when the Kit is in use.

FIG. 4: A magnified view of the mixing trays showing the overlapping feature in the closed position with thumb cutouts.

FIG. 5: A magnified view of the water evacuation system, including sponge well and water wells, showing the concave curvature in the separating walls that allows water to pass from the Kit and/or from one well to another.

FIG. 6: An exploded perspective view of the primary elements of the Kit in the open position illustrating the base, lid, 2 mixing trays and palette.

FIG. 7: An perspective view of the Kit in the open position with exploding elements including full pan container tray, half pan palette container, full pan palette option, paint cups, sponge, easel, water bottle, and swatch card.

FIG. 8: The back perspective view of the Kit in the closed position illustrating the base hinge columns and lid hinge brackets connecting the two parts via the hinge pin.

FIG. 9: An exploded back view of the Kit illustrating the hinge system with the lid in the open position resting in a 120° angle.

FIG. 10: A perspective view of the bottom of the Kit in a slightly open position illustrating the feet, tripod mount hole, drain and ventilation holes plus attachable hand holder.

FIG. 11: The perspective view of the easel extender illustrating the easel tray in the open position and the easel hook attached via elastic band.

FIG. 12: A perspective view of the Kit in the open position illustrating the placement of the mixing trays hinge pins which connects the trays to the palette. Also illustrating the magnets embedded in the base and lid which securely hold the Kit closed when not in use. Plus, magnets which hold the easel in place.

FIG. 13: Front, side, top and perspective views of the brush holder.

### DETAILED DESCRIPTION OF THE INVENTION

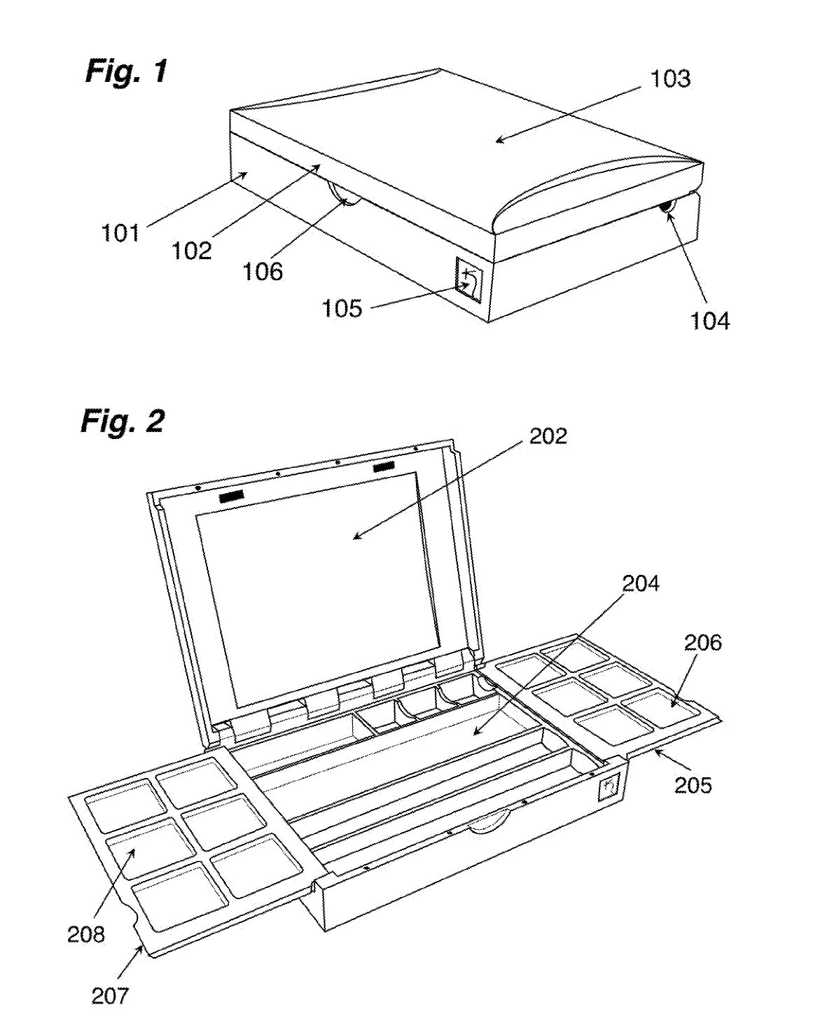

FIG. 1: The base 101 of the present embodiment of Keni's Art Kit, henceforth referred to as the ‘Art Kit’ is comprised of a base made of molded plastic with two paralleled side walls and front and back paralleled walls connected perpendicularly to a bottom wall and hingedly attached at the back wall to the lid 102. The base front has a thumb inset 106 and the inventor's registered trademark ‘K’ 105 embossed within. The right side wall has a pour spout 104 notched in it that allows water to be dispensed from within the Art Kit. The lid 102 is is made of molded plastic and is comprised of two paralleled side walls and front and back paralleled walls connected perpendicularly to a top wall. Said lid hingedly attaches at the back wall to the base 101. The lid's dome structure 103 strengthens the lid, avoiding a depression in the lid as it might happen if it were flat. It also serves as an elegant design feature. This unique design element is repeated on other Art Kit parts. Exterior dimensions of the Art Kit measure approximately 20.3×15.3×5 (cm-LWH).

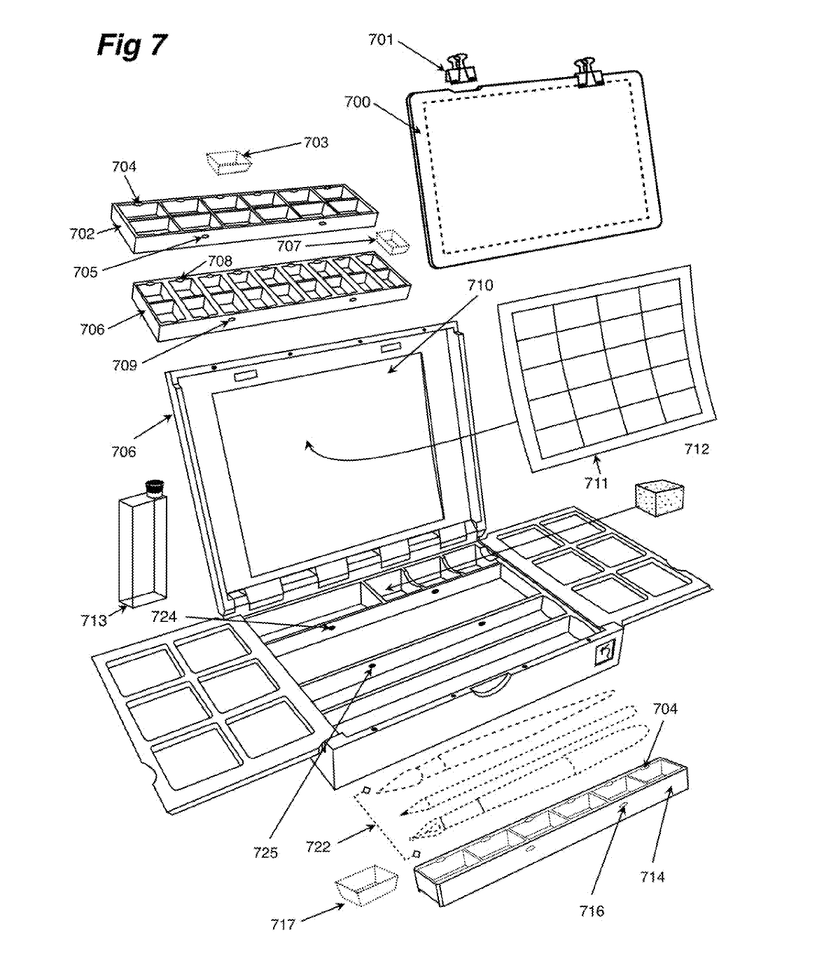

FIG. 2: The Art Kit in the open position. The lid (refer to FIG. 1: 101) is hingedly connected at the back to the back of the base (refer to FIG. 1 102). The interior lid is deep enough to allow extra sheets of paper to be stored behind the easel (see FIG. 7: 700). A portion of the interior lid 202 is concave. This serves several purposes. First, to strengthen the lid. Next, it serves as a space for a swatch card (Refer to FIG. 7: 711) to be affixed. Thin pamphlets, i.e., tracts, etc. can also be placed in here. The palette 204 snaps into the base. The right paint mixing tray 205, has six deep mixing wells 206 for the purpose of mixing paints. The left paint mixing tray 207, has six deep mixing wells 208 for the purpose of mixing paints. Both paint mixing trays hingedly attach to the base. The palette and trays are made of molded plastic.

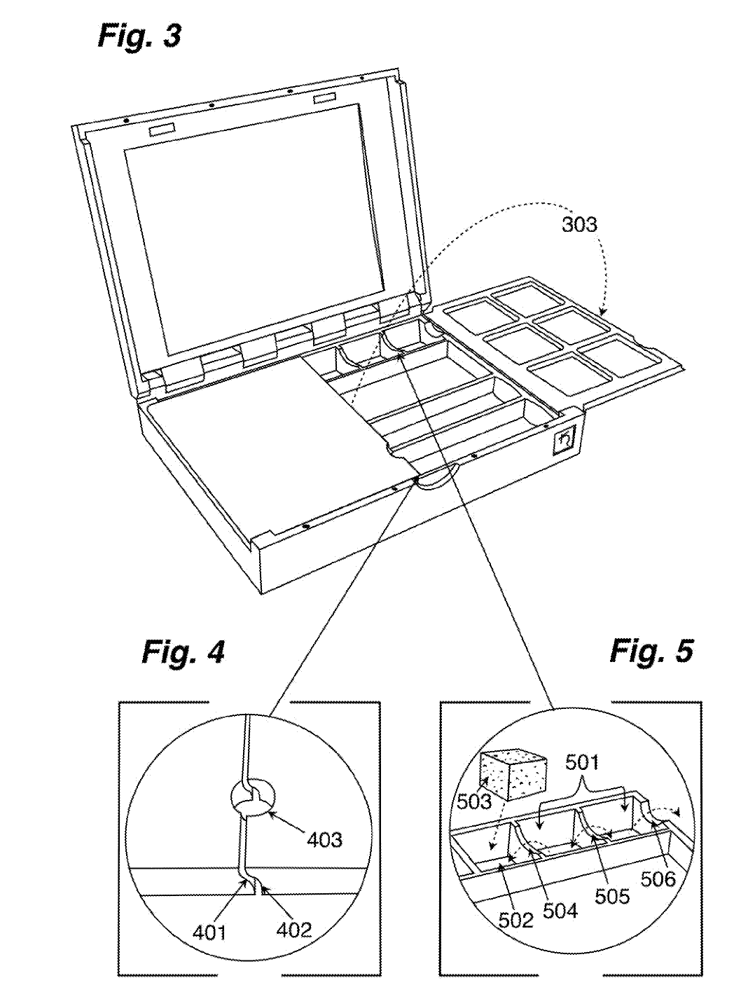

FIG. 3: The interior Art Kit highlighting the functionality of the paint mixing trays. The left paint mixing tray 301 is illustrated in the closed position. The right paint mixing tray is illustrated in the open position. This illustration demonstrates how the tray swivels out 180° 303 from the closed position to the open position. The same is true of the left mixing tray. When opened, they both rest on the base in a flat horizontal plane.

FIG. 4: An exploded view of the paint mixing trays in the closed position. 401 illustrates an overlapping serpentine curvature of the left tray on the leading edge and the right tray 402, which also has a serpentine curvature. The purpose of this interlocking feature is to help prevent paint or other liquids from seeping out of the palette when the Art Kit is closed and not sitting flat in the horizontal position, such as would happen when being transported. 403 illustrates the thumb notches that allow the paint mixing trays to be opened easily. These thumb notches are carefully positioned away from the paint wells in the palette. An additional feature of the overlapping tray design is to inhibit drying of paint beneath the mixing trays and within the palette.

FIG. 5: An exploded view of the water evacuation system 501 and sponge well 502 related to water usage and disposal. The two water wells are provided so that one water well can remain relatively clean while the other gets progressively dirty during the painting session. The sponge 503 serves several purposes. One, it is used to absorb paint and water from the paintbrush during the painting process. Next, it serves as a moisturizer, helping to keep the paints from drying when the Art Kit is not in use. The sponge can also be used to absorb water from the water wells. This can happen several ways. First, the sponge can be removed and dipped into the water wells, thus absorbing water. The second way is accomplished owing to the concave curvature in the dividing walls 504 and 505. When the sponge remains in its well, the Art Kit can be gently tilted downwards to the left, thus causing the water to run from their wells into the well containing the absorbent sponge. This is very handy when painting indoors and not having a convenient place to dispose of the water. The quickest way of emptying the water wells after a painting session is to close the Art Kit, tilt it downwards to the right and shake it vigorously. This causes the water to be expelled from the water wells over the curved exterior spout 506. Thanks to the overlapping trays, (refer to FIG. 4: 401 and 402), when in the closed position, water will not spill onto the artwork clipped securely to the easel (refer to FIG. 7: 700) inside the lid.

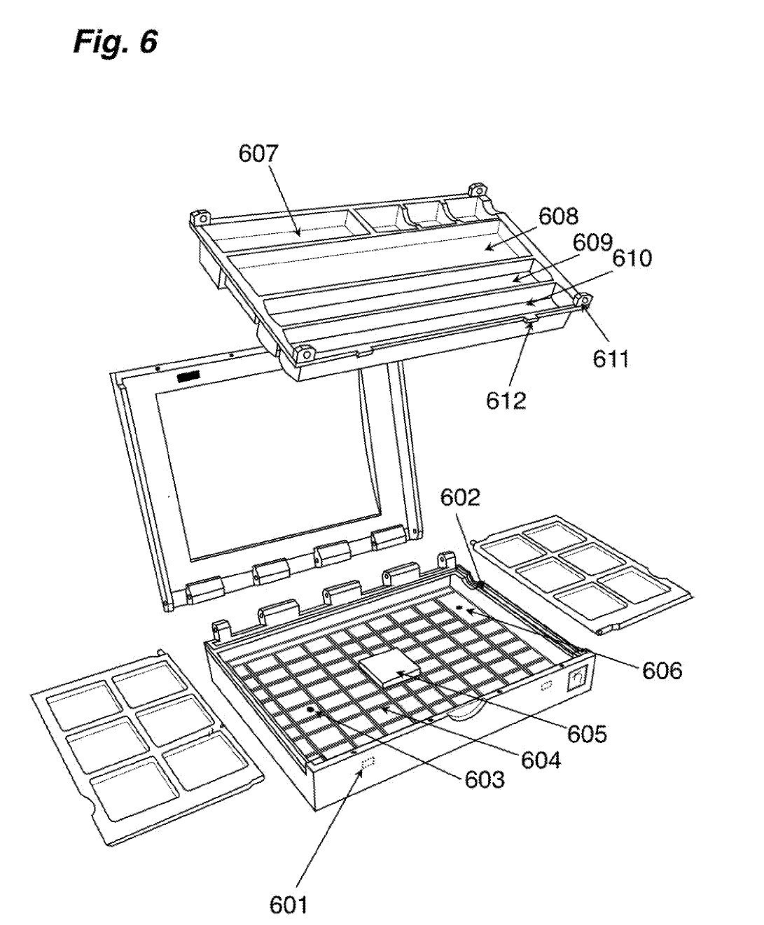

FIG. 6: Highlights of the interior base and the palette layout. Key features in the base interior include slots 601 that allow palette to be snapped into base. Shelf 602 upon which palette rests. An ejection hole 603 used for removing palette containers (refer to FIG. 7: 702 and 706) The bottom of the base is reinforced by raised cross hatching ribs 604. The solid block 605 is where the female tripod mount screw is inserted from the underneath side. A drain and ventilation hole 606 is positioned underneath the right water well. The palette (refer to FIG. 2: 204) is illustrated with these key features: Water bottle trough 607, sponge and water wells (refer to FIG. 5: 501, 502), palette option trough 608, rear tool trough 609, forward tool trough 610, mixing tray mounts 611, and palette tabs 612 used for snapping palette into base.

FIG. 7: Highlights the primary components and options that reside, or can reside within the Art Kit. The easel 700 is the removable surface upon which the drawing or painting surface is secured using standard ½″ binder clips 701.

The full pan palette option container 702 accommodates full pan cups 703 into which water media (watercolor, gouache, acrylics, etc.) can be placed. Lift out notches 704 are placed in each well that allow the cups to be easily removed. Small oval extrusions 705 are placed along the sides of the palette container. These extrusions match the indentations 724 set within the palette. When the full pan palette container is inserted in the palette, the extrusions snap within the indentations, causing the palette container to rest securely within the Art Kit.

The half pan palette option container 706 accommodates standard half pan cups 707 into which water media (watercolor, gouache, acrylics, etc.) can be placed. lift out notches 708 are set in each well that allow the cups to be easily removed. Small oval extrusions 709 are placed along the sides of the palette container. These extrusions match the indentations 724 set within the palette. When the half pan palette container is inserted in the palette, the extrusions snap within the indentations, causing the palette container to rest securely within the Art Kit.

The concave recessed area 710 within the lid is intended for use with a swatch card 711. The card is used for painting color samples which can be inserted within this area. A sponge is placed in the sponge well (refer to FIG. 5: 502). The transparent water bottle 713 is placed in the water bottle trough (refer to FIG. 6: 607).

The full pan palette extender option 714 accommodates full pan cups 717 into which water media (watercolor, gouache, acrylics, etc.) can be placed. Lift out notches 715 are placed in each extender well that allow the cups to be easily removed. Small oval extrusions 716 are placed along the sides of the palette extender option. These extrusions match the indentations 725 set within the palette. When the palette extender option is inserted in the palette, the oval extrusions snap within the indentations, causing the palette container to rest securely within the Art Kit.

The half pan palette extender option 718 accommodates half pan cups 721 into which water media (watercolor, gouache, acrylics, etc.) can be placed. Lift out notches 719 are placed in each extender well that allow the cups to be easily removed. Small oval extrusions 720 are placed along the sides of the palette extender option container. These extrusions match the indentations 725 set within the palette. When the palette extender option is inserted into the palette, the oval extrusions snap within the indentations, causing the palette extender option to rest securely within the Art Kit.

Illustration 722 indicates the types of tools that can be put in the forward and rear tool troughs.

Material used for manufacturing the interior components (full and half pans containers plus options, cups, palette, easel, transparent water bottle and mixing trays is molded plastic. Material used for manufacturing the easel is Black ABS. Material for manufacturing the water bottle is transparent plastic. Swatch card is made of #140 white cold press watercolor paper with with a 20 grid pattern printed on it.

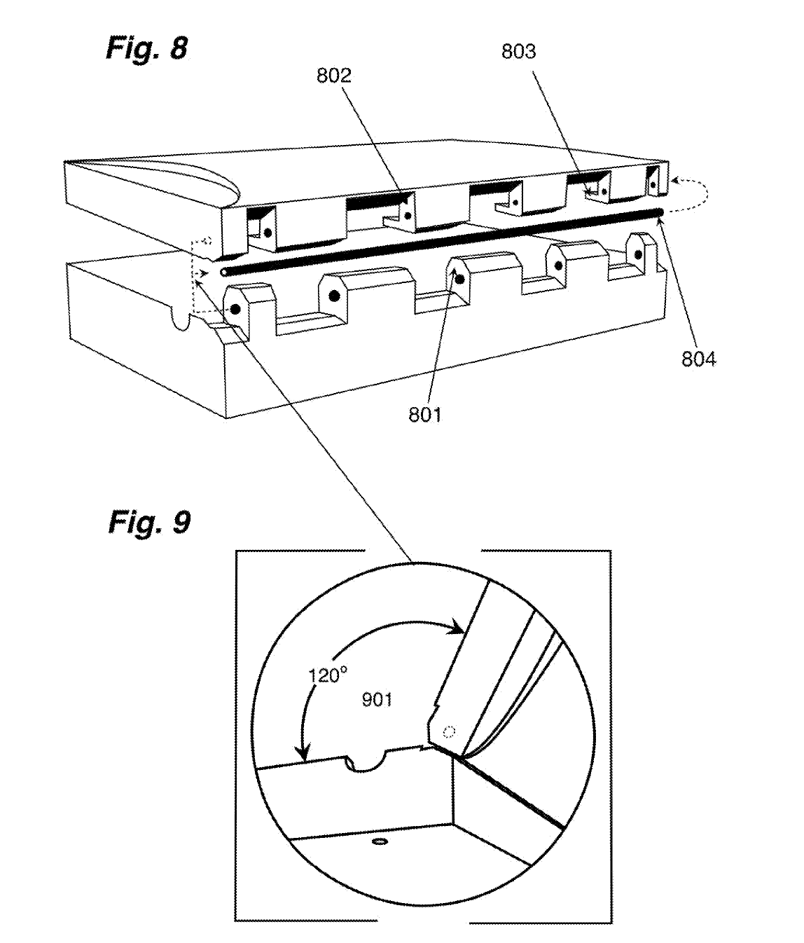

FIG. 8: A perspective view of the rear of the Art Kit having the lid expanded up from the base in order to highlight the hinge system. The massive hinge sections connect the base hinge columns 801 to the lid hinge brackets 802. Also included in the lid hinge brackets is the easel shelf 803 (refer to FIG. 7: 700). Connecting the lid to the base is performed by first lowering the lid into position till the holes are aligned. Then insert the hinge rod 804 first through the lid. As it proceeds, it alternates between lid and base brackets and posts until fully inserted. The entry hole is then sealed to match the lid.

FIG. 9: An illustration of how the lid hingedly rotates 120° 901 from a closed position on the base to the open position. This angle is ideal for creating art within the lid whether the Art Kit is used on a table, held in the hand or mounted on a tripod. The hinge system is extra strong, allowing pressure to be put on the easel within the lid during the creative process.

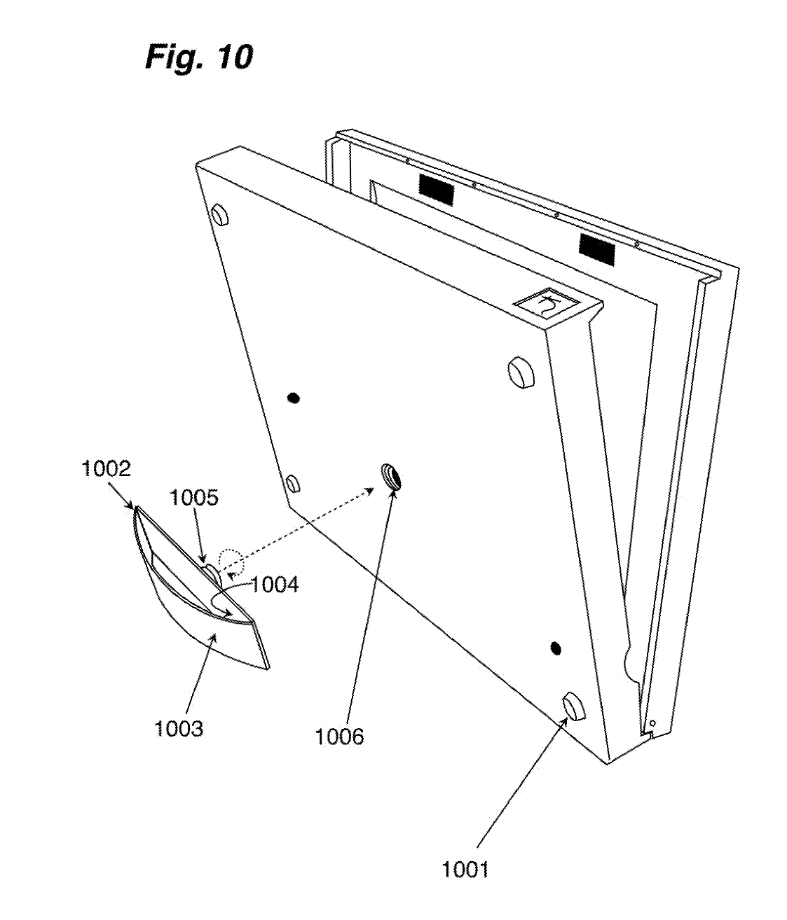

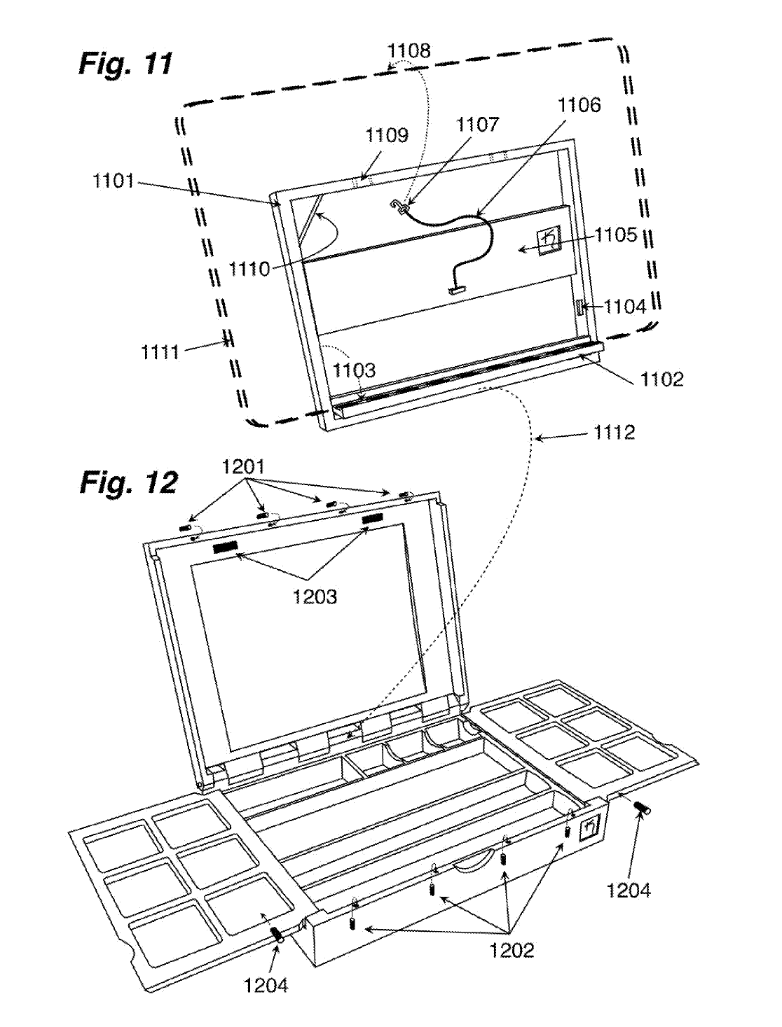

FIG. 10: A perspective view illustrating the bottom of the Art Kit. There are four non-skid rubber feet 1001 molded into the base of the Art Kit. The feet hold the Art Kit high enough above a flat surface that will allow the hand holder 1002 to remain on the Art Kit unless intentionally removed. The hand holder consists of an elastic band 1003 fastened to a thin metal plate 1004. A tripod screw 1005 is attached to the plate, allowing the hand holder to be screwed onto the bottom of the Art Kit. The tripod nut 1006 is inserted into the center of the base of the Art Kit. This will allow the Art Kit to be mounted on a tripod or to connect to the hand holder. An ejection hole (refer to FIG. 6: 602) will allow a small rod to be inserted in order to push a palette container (refer to FIG. 7: 702 and 706) out of the easel. A drainage and ventilation hole (refer to FIG. 6: 605) is positioned under the right water well of the palette.

FIG. 11: A perspective view of the easel extender frame 1101. The easel extender is fitted with a shelf 1102 which rotates down 90° 1003 from within the frame. When in the downward position, larger, oversized easels 1111 can be placed on the shelf. An elastic band 1106 with a hook 1107 fastened to its end stretches 1108 to secure the larger easel to the easel extender. When not in use, the hook wraps once around the frame brace 1105 and hooks onto the cross member 1110. When rotated back up into the stowed position, the easel extender shelf snaps into an indent 1104 in the frame in a locked position. Metal strips adhere to the notches 1109 in the frame, which snaps it to the magnets (see FIG. 12, 1203). The Easel extender can reside and remain inside the Art Kit, even when closed.

FIG. 12: A perspective view of the Art Kit in the open position highlighting the magnet closure system and mixing tray pins. Four tiny cylindrical magnets 1201 are inserted flush into holes on the bottom of the front face of the lid. Four tiny cylindrical magnets 1202 with reverse polarity are inserted flush into holes on the top of the front face of the base. When the Art Kit lid and base come into contact, the Art Kit is securely held closed by the attraction of the magnets. Two rectangular magnets 1203 are fastened inside the lid. Their purpose is to secure the easel extender (refer to FIG. 11: 1101) in place when in use. Two small pins 1204 connect the front of the mixing trays to the mixing tray mounts (refer to FIG. 6: 610) on the base, allowing the trays to swivel open and closed.

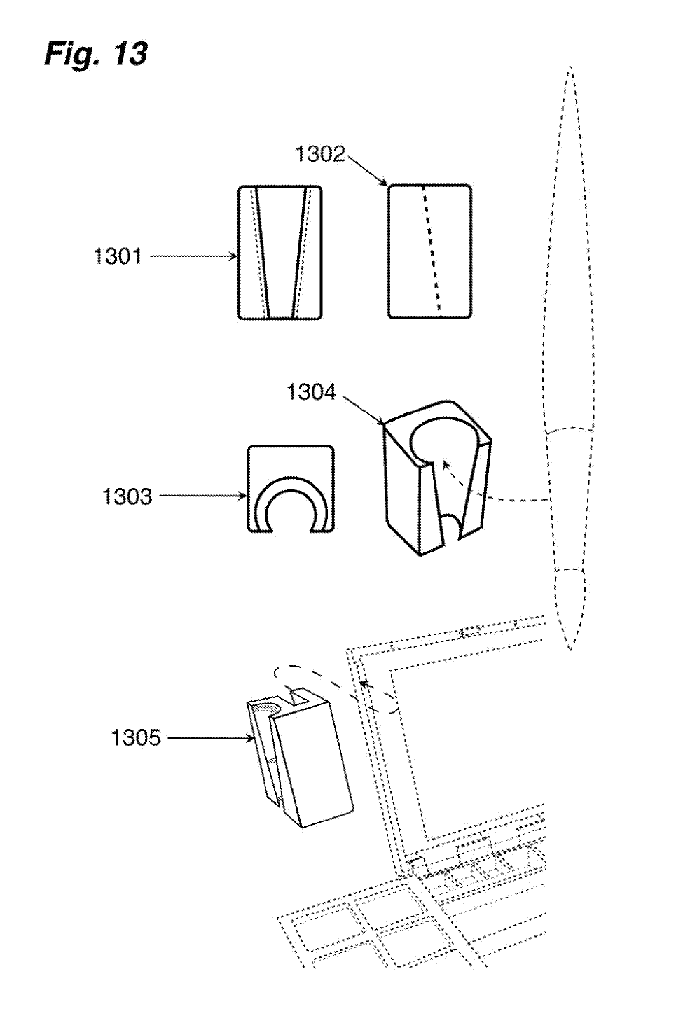

FIG. 13: The paint brush holder is illustrated in five views. A key feature is that brushes can be inserted; ideally at the ferrel but also at the handle in the upright position without disturbing or damaging bristles. 1301 is the front view showing the tapered cylindrical shape remaining after approximately one third of front is cut away, leaving an open cylinder. 1302 is the side view. 1303 is the side view. 1304 is a perspective view of the brush holder indicating how a paintbrush is inserted into the holder. 1305 is a perspective view illustrating a slot cut partially through the side, allowing the brush holder to be attached to the side of the lid. Various sizes of brush holders are made possible by varying the size and angle of taper in the cylinder. Brush holder can stored in the kit when not in use.

Field tested: From earlier versions of Keni's Art Kit to the final design prototype nearly one year later, the Art Kit has undergone rigorous testing by the designer and other professional artists. Hundreds of works of art have been created within the Art Kit revealing along the way the need for minute to major changes. Having made those alterations, the Art Kit is poised to be the most efficient and desired travel art Art Kit available to the creative community. It is suited for the occasional doodler and the fledgling artist. Equally important, it is ideal in meeting the demands of the professional artist making short hops to the local coffee shop to extended trips around the world.

I claim:

1. An Art Kit of the present invention comprised of:
(a) a main body, the base made of molded plastic with two paralleled side walls and front and back paralleled walls connected perpendicularly to a bottom wall and hingedly attached at the back wall to the lid of similar construction.
(b) Said base contains a palette, a hand holder/tripod attachment nut on the underside, said base having feet that hold Kit above a flat surface, said base having an interior shelf and slots upon and into which the palette is secured in place, said base having magnets that allow it to be secured to the lid in the closed position, said base having substantial hinge columns which connect it to the lid.
(c) Said lid holds the removable easel and sheets of drawing or painting surfaces upon which artwork can be completed within the Kit lid, said lid having a concave area to hold other material, said lid having a convex dome construction on its top, said lid having magnets that hold the easel and easel extender securely in place, said lid having magnets that allow it to be secured to the base in the closed position, said lid having substantial hinge brackets which connect it to the base, whereby hinge system in the open position comes to rest at approximately 120 degrees at which flat surfaces of lid and base precisionly meet to hold the lid open for completing artwork within the lid, said lid use as a support for the brush holder.

2. The Art Kit according to claim 1 having a palette made of molded plastic with unique water evacuation system plus palette improvements comprising in combination
(a) concave dividing walls that allow dispensable water to be drained internally into the sponge well (most effective when open) when the Kit is tilted downward to the left, plus said concave dividing walls with spout extending outward that allow dispensable water to be drained externally from the Art Kit (most effective when closed) when tilted downward to the right.
(b) palette extends from front to back and side to side within the base.
(c) deep, integrated wells and troughs that hold paints, brushes, pens, pencils, water bottle, sponge plus other materials and supplies.
(d) four mounts that support two mixing trays
(e) tab indents for securing palette containers
(f) multiple water wells.
(g) rests on base shelf
(h) tabs for snapping palette into base slots
(i) removable for repair or replacement

3. The Art Kit according to claim 2 having paint mixing trays made of molded plastic with unique overlapping leading edges plus improvements comprise in combination
(a) mixing trays hingedly attached to the palette allowing storage within the Kit when not in use and rotating outwardly 180 degrees to a horizontal position for use
(b) overlapping leading edges which, in the closed position, help prevent paint or other liquids from spilling out of their wells, thus helping to avoid spoilage of artwork and paper within the lid.
(c) a thumb notches on each tray, allowing the trays to be rotated open
(d) a plurality of deep wells that allow multiple colors to be mixed without contaminating others
(e) when mixing trays are closed, palette troughs and wells are covered, thus inhibiting paint from drying and helping to keep tools and supplies in place
(f) removable for repair or replacement

4. The palette according to claim 2 having removable, replaceable palette option containers and palette extender containers made of molded plastic wherein improvement comprises
(a) palette option container with wells with lift-out notches that hold standard sized watercolor half pan cups
(b) palette option container with wells with lift-out notches that hold standard sized watercolor full pan cups
(c) palette extenders container with wells and lift-out notches that hold standard sized watercolor full pan cups
(d) oval extrusions that snap containers securely into palette

5. The Art Kit according to claim 1 having a removable easel extender made of molded plastic comprising
(a) a frame sized to fit within the lid, even when closed
(b) a hingdely rotating shelf that opens 90 degrees upon which is mounted larger, oversized easels, said shelf snaps securely closed when not in use
(c) an elastic band, one end attached to the palette extender frame brace, the other end attached to the hook for the purpose of holding oversized easels securely to the shelf.

6. Art Kit according to claim 1 having removable brush holder made of molded plastic comprising
(a) two paralleled side walls and front and back paralleled walls connected perpendicularly to a bottom wall and a top wall in a solid form
(b) a tapered cylinder bored from top wall through bottom wall; the top of cylinder being larger than the bottom where cylinder exits
(c) the side of the front wall is cut away leaving approximately two thirds of cylinder remaining while back and side walls remain intact.
(d) angle of cone bored into box can be changed, allowing brushes to rest at different angles
(e) various size paint brushes can be inserted and held (ideally at metal ferrel) securely into remaining portion of cone depending on ratio of opening at top to the opening at bottom
(f) paint brushes can be inserted without concern of damaging bristles
(g) incidental to the brush holder is the angle of bore and mounting mechanism, i.e., slot, clip or otherwise
